(19) United States
(12) Patent Application Publication
(10) Pub. No.: US 2015/0149614 A1
(43) Pub. Date: May 28, 2015

(54) ASCERTAIN TETHERING OF DEVICE

(71) Applicant: T-Mobile USA, Inc., Bellevue, WA (US)

(72) Inventor: Ruchir SINHA, Bellevue, WA (US)

(73) Assignee: T-Mobile USA, Inc., Bellevue, WA (US)

(21) Appl. No.: 14/091,533

(22) Filed: Nov. 27, 2013

(51) Int. Cl. H04W 8/24; H04W 8/00

(52) U.S. Cl. CPC H04W 8/24; H04W 8/005
USPC 709/224

(57) ABSTRACT

Systems, methods and procedures are described for ascertaining tethering of a device in a communication network. In one implementation, a wireless device provides Internet connectivity to a computing device using a wireline or wireless transmission medium. In one arrangement, the wireless device, in the tethered arrangement with the computing device, may provide receiving and sending of data communications capability to the computing device. In one implementation, the communication entity that is hosting the network may ascertain that tethering is occurring by analyzing communications generated or passing through the computing device.

### BACKGROUND

Wireless devices that are configured to communicate with a wireless network may also be configured to allow other devices to communicate with the wireless network via the wireless device. This is often called “tethering.” Current devices capable of providing tethering services provide a conduit for the tethered device to access the Internet and other resources that are available via the wireless network. The network for which the tethering wireless device facilitates communication for the tethered device may not have knowledge of the tethered device. Unauthorized tethering consumes bandwidth from the network service provider without paying for the service.

### BRIEF DESCRIPTION OF THE DRAWINGS

The detailed description is forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure.

FIG. 1 illustrates a wireless communication system.

FIG. 2 is a diagrammatic representation of an example arrangement in which one or more network elements, such as those illustrated in FIG. 1, ascertaining a tethering arrangement.

FIG. 3 is a flowchart of a process that may be implemented to ascertain a tethering arrangement.

FIG. 4 is an illustrative computing device that may be used to implement implementations described herein.

### DETAILED DESCRIPTION

Systems, methods and procedures are described for ascertaining tethering of a device in a communication network. In one implementation, a wireless device provides Internet connectivity to a computing device using a wireline or wireless transmission medium. For example, the wireless device may be capable of receiving and sending voice and data communications using a network that is hosted by a communication entity. The wireless device, in a tethered arrangement with the computing device, may provide the receiving and sending of voice and data communications capability to the computing device that is otherwise unable of receiving and sending voice and data communications via the network. In one arrangement, the wireless device, in the tethered arrangement with the computing device, may only provide receiving and sending of data communications capability to the computing device. In one implementation, the communication entity that is hosting the network may ascertain that tethering is occurring by analyzing communications generated or passing through the computing device. For example, the network may receive one or more communications from the computing device, via the wireless device providing a tethered arrangement, that indicates a screen resolution is different than the screen resolution of the wireless device. Such screen resolution information may be derived from scripts generated by for example, one or more webpages, associated uniform resource locator (URL) information, and/or, computer generated code or executed code obtained from the computing device. Furthermore, such screen resolution information may be derived from general hypertext transfer protocol (HTTP) information provided from the computing device, via the wireless device providing the tethered arrangement.

The terms “wireless communication device,” “wireless communication device,” “computing device,” “mobile device” or “user device,” as used herein and throughout this disclosure, refers to any electronic device capable of wirelessly and/or wireline sending and receiving data. A wireless device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories).

Wireless devices may communicate with each other and with other elements via a network, for instance, a wireless network, or a wireline network. A network may include broadband wide-area networks such as cellular networks, local-area networks (LAN), Wi-Fi, and personal area networks, such as NFC networks including Bluetooth®. Communication across a network may be packet-based; however, radio and frequency/amplitude modulation networks may enable communication between communication devices using appropriate analog-digital-analog converters and other elements. Communication may be enabled by hardware or mixed hardware and software elements called transceivers. Wireless devices may have more than one transceiver, capable of communicating over different networks. For example, a cellular telephone may include a cellular transceiver for communicating with a cellular base station, a Wi-Fi transceiver for communicating with a Wi-Fi network, and a Bluetooth® transceiver for communicating with a Bluetooth® device. A Wi-Fi network is accessible via access points such as wireless routers, etc., that communicate with the Wi-Fi transceiver to send and receive data. The Wi-Fi network may further be connected to the internet or other packet-based networks. The bandwidth of a network connection or an access point is a measure of the rate of data transfer, and can be expressed as a quantity of data transferred per unit of time.

A network typically includes a plurality of elements that host logic or intelligence for performing tasks on the network. The logic can be hosted on servers. In modern packet-based wide-area networks, servers may be placed at several logical points on the network. Servers may further be in communication with databases and can enable communication devices to access the contents of a database. Billing servers, application servers, etc. are examples of such servers. A server may include several network elements, including other servers, and can be logically situation anywhere on a service provider's network, such as the back-end of a cellular network

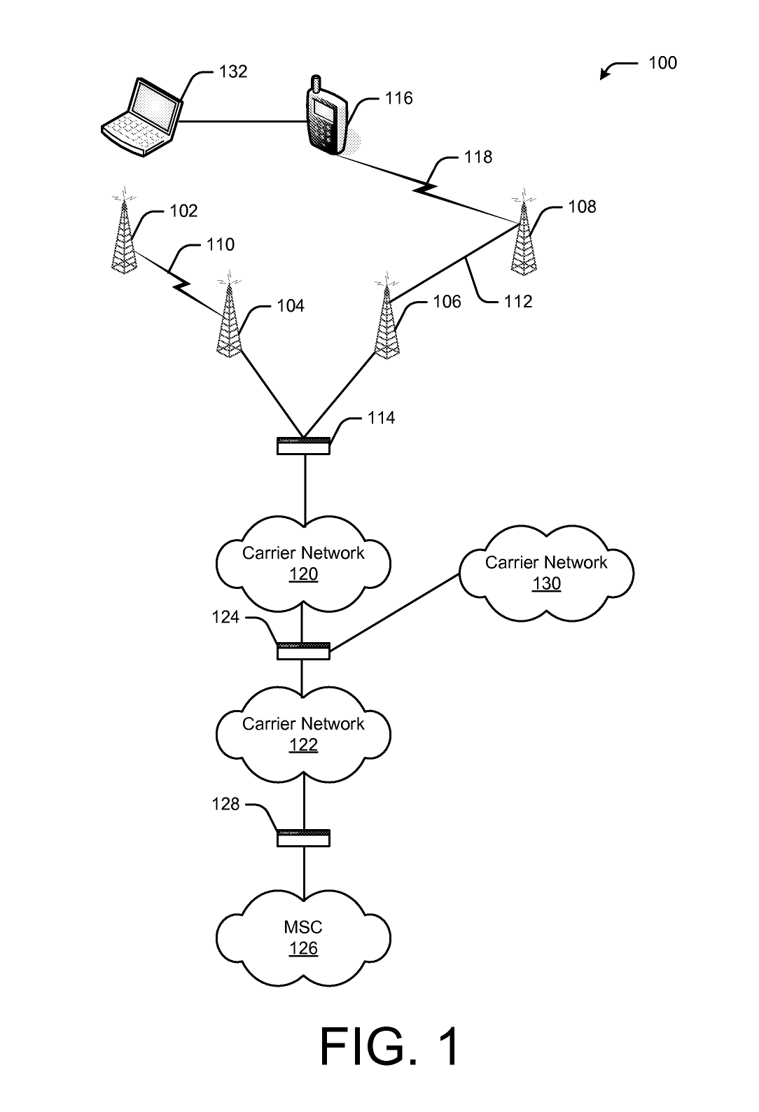

FIG. 1 illustrates a wireless communication system 100. The wireless communication system 100 may also be generally referred to as the network 100. The wireless communication system 100 may employ multiple base stations 102, 104, 106 and 108. The base station 102 is shown as being coupled to the base station 104 by way of a wireless communication link 110. The base station 108 is shown as being coupled to the base station 106 using a wire or optical link 112. Each of the base stations 104 and 106 is shown as being coupled to a router 114. The link between the router 114 and the base stations 104 and 106 may be wire or wireless link implemented. A wireless device 116, such as a mobile phone, may be coupled to the base station 108 via wireless signals 118.

A plurality of carrier networks 120 and 122 may be used in the wireless communication system 100. A router 124 may couple the two carrier networks 120 and 122. A mobile switching center (MSC) 126 may be coupled to the carrier network 122 through a router 128. Depending on the network type, the MSC 126 may also be a packet data network gateway (PGW) or a gateway GPRS support node (GGSN). Generally, wired links are used between the router 114 and the MSC 126. However, wireless connectivity may also be used. To enable further expansion of the wireless communication system 100, a further carrier network 130 may be implemented and which is shown as being coupled to the router 124. A plurality of routers (e.g., edge and internal routers) may be implemented within the ‘clouds’ illustrating the carrier networks 120, 122 and 130.

In a generic wireless communication system, there may be only a single carrier network that is to route traffic from the MSC to the base stations coupled to the carrier network. In such an arrangement, each base station is regarded as individual access point (AP), which is one wired hop through a router to access the carrier network. In other words, the end-to-end transport connection includes the MSC that receives and sends traffic from the carrier network to a base station (i.e., 1:1:1 traffic routing).

The wireless device 116 may provide a tethering connectivity for a general computing device 132. In one implementation, the wireless device 116 is connected wirelessly to the computing device 132. Such wireless connectivity may be provided by Bluetooth®, NFC, Wi-Fi, or the like. In another implementation, the wireless device 116 is connected using a wireline connection to the computing device 132. Such wireline connectivity may include Ethernet, USB, or the like. In general, the wireless device 116 providing the tethering connectivity for the computing device 132 means that the wireless device 116 is providing access to the communication system 100. Therefore, the computing device 132, by way of the tethering arrangement with the wireless device 116, may access the Internet by way of the communication system 100.

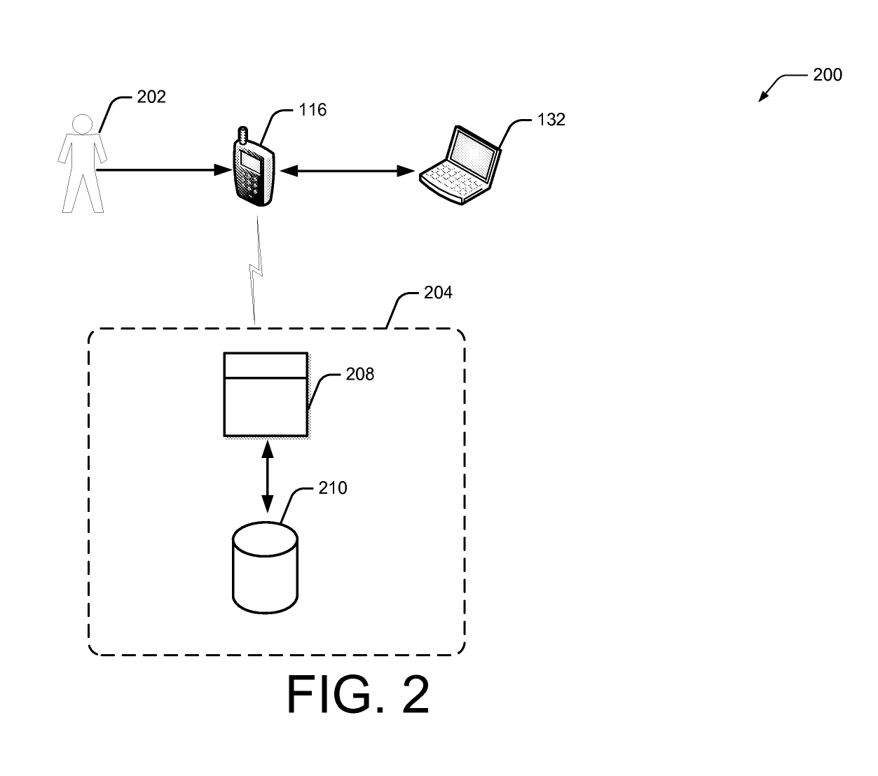

FIG. 2 is a diagrammatic representation of an example arrangement 200 in which one or more network elements, such as those illustrated in FIG. 1, detects a tethering arrangement. As shown, a user 202 may couple, either wirelessly or via a wireline connection, the wireless device 116 to the computing device 132. The wireless device 116 may be coupled wirelessly to a network 204. In general, the network 204 may include the network elements illustrated in FIG. 1. The network 204 may provide voice and data communication capability to the wireless device 116. The wireless device 116 may, via a connection with the computing device 132, provide the voice and/or data communication capability that is provided by the network 204 to the computing device 132.

The network 204 may include a server 208 that hosts a database 210. The server 208 may parse and analyze network traffic that is received from the wireless device 116. The network traffic that is received from the wireless device 116 may originate directly from the wireless device 116. However, it is also possible that in a tethering arrangement, such as that illustrated in FIG. 2, the network traffic is generated by the computing device 132 and passed to the network 204 via the wireless device 116.

Such parsed and analyzed data may be logically stored in the database 210, so that the data is searchable by the server 208. In one implementation, the searchable data in the database 210 includes webpage information received from the wireless device 116, HTTP information received from the wireless device 116, script and executable information related to webpages browsed by the wireless device 116, and the like. Such webpage information, HTTP information, script information, and executable information may also originate from the computing device 132. The database 210 may also include information related to wireless devices that are registered or subscribers of the network 204. For example, the database 210 may identify the make and model of the wireless device 116 used by the user 202. Furthermore, specifications related to the wireless device 116 may be stored in the database 210. For example, such specifications may include wireless device model related information, such as screen size and resolution, associated with the wireless device 116. Furthermore, the database 210 may identify that the wireless device 116 is or is not subscribed to a tethering plan, which generally requires that the end-user of the wireless device 116 is subject to a special tethering fee because of the amount of data that is consumed by the wireless device 116 when in a tethered arrangement, such as that illustrated in FIGS. 1-2.

Furthermore, the database 210 may store various data packet indicators. The indicators may be used to help identify what type of data packet is being sent to the wireless device 116 from the computing device 132. The indicator of the data packet may then be compared to the type of data packets that the network 204 should or should not be receiving from the wireless device 116 to help detect and identify whether the wireless device 116 is providing tethered connectivity for the computing device 132. For example, an Android OS implemented wireless device should not be receiving update data packets for a Windows® phone, or a wireless telephone should not be receiving data packets that are used only for laptop computers. As those of ordinary skill in the art will appreciate, there are many data packets that have included therein unique indicators that identify the data packets as being specific to a particular OS, software system, software platform, software program, and the like.

In a particular implementation, the type of data packet may be identified directly from the data packet received by the network 204. For example, the uniqueness of the data packet may be identified by analyzing a header file of the data packet. In one example, the header file itself, a user-agent field in the header or a host field in the header may be used to detect the uniqueness of the data packet. That is, the header file itself, a user-agent field in the header or a host field in the header may be used to detect if the associated data packet is one that should be expected from (originated) the wireless device 116, or the associated data packet is provided from a tethered computing device, such as the computing device 132.

Therefore, to summarize the foregoing, the network 204 may determine a tethering arrangement based on resolution information determined from data provided by the wireless device 116. That is, the network 204 may cross reference a received resolution information against resolution information stored in the database 210 and associated with the wireless device 116. If the received resolution information does not match the specifications of the wireless device 116, it may be surmised that the wireless device 116 is providing a tethering arrangement for the computing device 132. Furthermore, the network 204 may determine a tethering arrangement based on one or more indicators associated with one or more data packets of the wireless device 116. That is, the network 204 may analyze the one or more data packets to determine if indicators are present that show that the data packets did not originate directly from the wireless device 116. For example, the indicators may show that the data packets are specific to a particular OS, software platform, software protocol, or the like, that is not implemented by the wireless device 116. Again, the particular OS information and the like may be stored in the database 210 as being associated with the wireless device 116. Therefore, the network 204 may use such indicators to surmise that the wireless device 116 is providing a tethering arrangement for the computing device 132.

In another example, the indicators may show that the data packets are specific to a particular device type, such as the computing device 132, but not the expected wireless device 116. In one implementation, one of the indicators that may show that the data packets are specific to a particular device type is a URL embedded in a data packet or packets that is specific to the computing device 132, but not the expected wireless device 116. The network 204 may use such URL related indicators to surmise that the wireless device 116 is providing a tethering arrangement for the computing device 132. In one example, URLs provided by the wireless device 116 are different than those provided by the computing device 132. Therefore, the network 204 may cross reference information stored in the database 210 to determine if the URLs provided by the wireless device 116 match (e.g. the URLs have proper formatting for the device type) those that are expected from the device type of the wireless device 116. If the cross-referencing of the database 210 shows that the URLs provided by the wireless device 116 do not match those that are expected from the device type of the wireless device 116, the network 214 may surmise that the wireless device 116 is providing a tethering arrangement for the computing device 132 as a result of the unexpected URL information received from the wireless device 116.

In one implementation, when the network 204 determines an unauthorized tethering arrangement in accordance with the foregoing, the network 104 may send a notification (e.g., SMS or email) to the wireless device 116 warning that unauthorized tethering was detected. Furthermore, or in a particular example, the notification may suggest modification of an associated end-user agreement to include a tethering subscription plan.

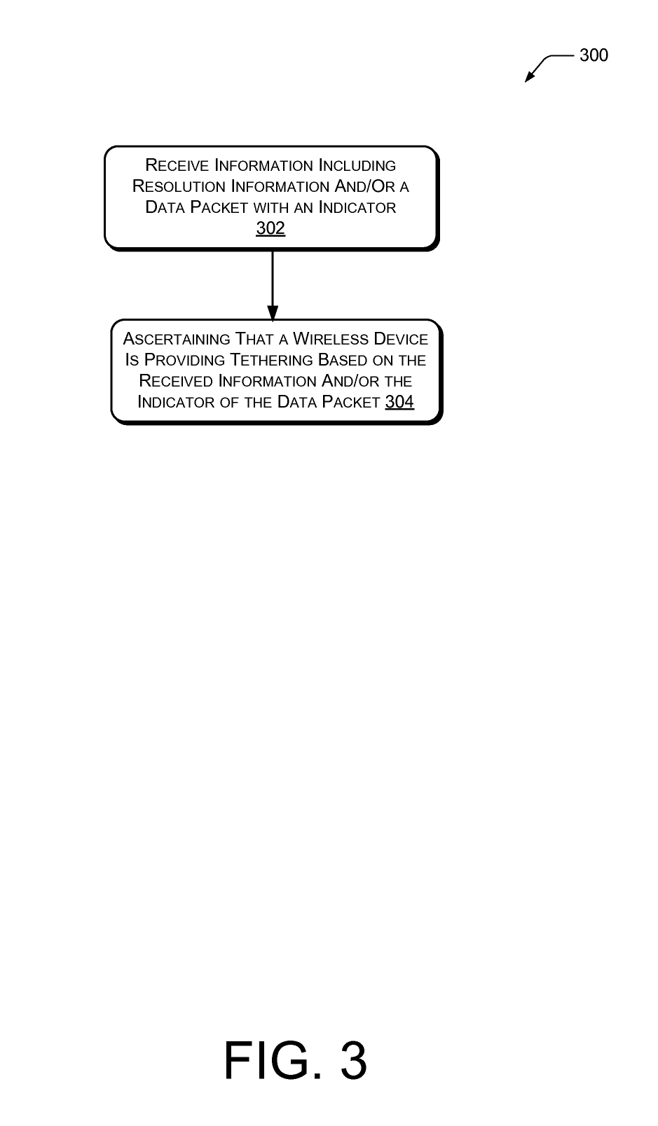

FIG. 3 is a flowchart of a process 300 that may be implemented to ascertaining a tethering arrangement. The process 300 may be executed by any device or entity within a communication system, such as the devices and other arrangement illustrated in FIGS. 1-2 and 4.

At act 302, a network element or device or arrangement of devices receives information including resolution information and/or a data packet with an indicator. At act 504, the network element or device or arrangement of devices ascertains that a wireless device is providing tethering based on the received information and/or the indicator the data packet.

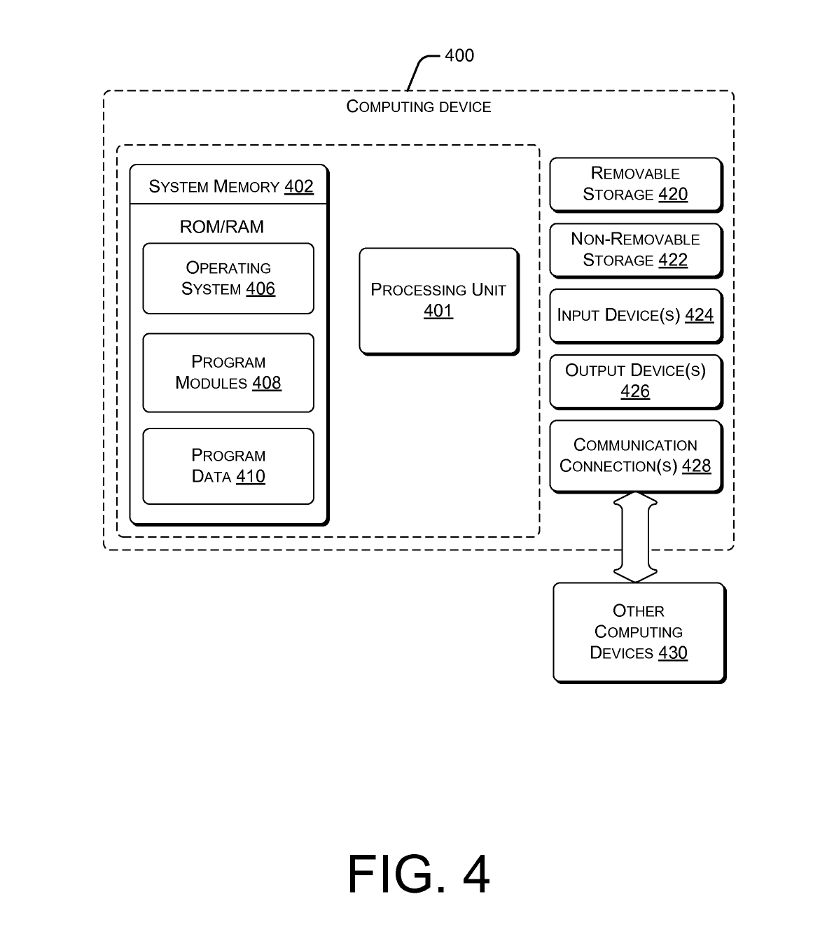

FIG. 4 is an illustrative computing device 400 that may be used to implement implementations described herein. In particular, the computing device 400 may be used to implement one or more of the elements illustrated in FIGS. 1-2. In a very basic configuration, the computing device 400 includes at least one processing unit 401 and a system memory 402. Depending on the exact configuration and type of the computing device 400, the system memory 402 may be volatile (such as RAM), non-volatile (such as ROM, flash memory, etc.) or some combination of the two. The system memory 402 typically includes an operating system 406, one or more program modules or applications 408, and may include program data 410 in the form of, in one implementation, executable instructions.

The computing device 400 may have additional features or functionality. For example, the computing device 400 may also include additional data storage devices (removable and/or non-removable) such as, for example, magnetic disks, optical disks, or tape. Such additional storage is illustrated in FIG. 400 as a removable storage 420 and a non-removable storage 422. Computer storage media may include volatile and nonvolatile, removable and non-removable media implemented in any method or technology for storage of information, such as computer readable instructions, data structures, program modules, or other data. The system memory 402, removable storage 420 and the non-removable storage 422 are all examples of computer storage media. Thus, computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 400. Any such computer storage media may be part of the device 400. The computing device 400 may also have an input device(s) 424 such as keyboard, mouse, pen, voice input device, touch input device, etc. An output device(s) 426 such as a display, speakers, printer, etc. may also be included. These devices are well known in the art and need not be discussed at length.

The computing device 400 may also contain a communication connection 428 that allows the device to communicate with other computing devices 430, such as over a wireless or wireline network (e.g. the Internet). The communication connection(s) 428 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media can be any available media that can be accessed by a computer. By way of example, and not limitation, computer readable media may comprise “computer storage media” and “communications media.”

In the above description of implementations, for purposes of explanation, specific numbers, materials configurations, and other details are set forth in order to better explain the invention, as claimed. However, it will be apparent to one skilled in the art that the claimed invention may be practiced using different details than those described herein. In other instances, well-known features are omitted or simplified to clarify the description of the implementations.

The inventors intend the described implementations to be primarily examples. The inventors do not intend these implementations to limit the scope of the appended claims. Rather, the inventors have contemplated that the claimed invention might also be embodied and implemented in other ways, in conjunction with other present or future technologies.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

The processes discussed herein may be implemented with hardware, software, firmware, or any combination thereof. In the context of software/firmware, instructions stored on one or more processor-readable storage media that, when executed by one or more processors, may perform the recited operations. The operations of the processes may be rendered in virtually any programming language or environment including (by way of example and not limitation): C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (BREW), and the like.

Processor-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

What is claimed:

1. A computer implemented method, comprising:
receiving resolution information from a wireless device;
ascertaining that the wireless device is performing tethering based on the received resolution information.

2. The method of claim 1, further comprising comparing the received resolution information to a known screen resolution of the wireless device.

3. The method of claim 2, wherein the act of comparing includes retrieving the known screen resolution of the wireless device from a database.

4. The method of claim 1, further comprising transmitting a notification to the wireless device, the notification indicating observance of tethering being performed by the wireless device.

5. A server device comprising:
one or more processors; and
computer-executable instructions which, when executed by the one or more processors, perform operations including:
receiving resolution information from a wireless device;
ascertaining that the wireless device is performing tethering based on the received resolution information.

6. The network system according to claim 5, wherein the operations further include comparing the received resolution information to a known screen resolution of the wireless device.

7. The network system according to claim 6, wherein the operations further include retrieving the known screen resolution of the wireless device from a database coupled to the server device.

8. A computer-implemented method comprising:
analyzing a data packet received from a mobile device;
detecting an indicator from the analyzing the data packet; and
ascertaining that the wireless device is performing tethering based on the detected indicator.

9. The method to ascertain tethering according to claim 8, wherein the act of ascertaining includes ascertaining that the wireless device is performing tethering based on the detected indicator showing that the data packet is incompatible with the mobile device.

10. The method to ascertain tethering according to claim 8, wherein the indicator indicates operating system information, the operating system information being incompatible with the mobile device.

11. A non-transitory computer-readable medium having stored thereon a plurality of instructions, the plurality of instructions including instructions which, when executed by a processor, cause the processor to perform operations comprising:
analyzing a data packet received from a mobile device;
detecting an indicator from the analyzing the data packet; and
ascertaining that the wireless device is performing tethering based on the detected indicator.

10. The non-transitory computer-readable medium of claim 11, wherein the analyzing includes examining a header of the data packet.

11. The non-transitory computer-readable medium of claim 11, wherein the analyzing includes examining the data packet for operating system information.

12. The non-transitory computer-readable medium of claim 11, wherein the act of ascertaining includes ascertaining that the wireless device is performing tethering based on the detected indicator showing that the data packet is incompatible with the mobile device.

13. The non-transitory computer-readable medium of claim 11, wherein the indicator indicates operating system information, the operating system information being incompatible with the mobile device.

14. A computer implemented method, comprising:
receiving an indicator from a wireless device; and
ascertaining the wireless device is performing tethering based on the indicator, the indictor being associated with a universal resource locator (URL) that is not expected from the wireless device.

15. The method to ascertain tethering according to claim 14, wherein the act of ascertaining ascertains the wireless device is performing tethering based a determination that the detected URL was generated by a device other than the wireless device.

16. The method to ascertain tethering according to claim 14, wherein the act of ascertaining includes at least cross-referencing the received URL against one or more stored URL formats that are compatible with the wireless device.

17. The method ascertain tethering according to claim 14, further comprising receiving at least one packet from the wireless device, the at least one packet having the indicator embedded therein.

18. An apparatus, comprising:
a processor configured to:
receive an indicator from a wireless device; and
ascertain the wireless device is performing tethering based on the indicator, the indictor being associated with a universal resource locator (URL) that is not expected from the wireless device.

19. The apparatus of claim 18, wherein the processor is further configured to cross reference the URL against one or more stored URL formats that are compatible with the wireless device.

20. The apparatus of claim 14, wherein the indicator is embedded in a packet provided by the wireless device.
